(19) United States
(12) Patent Application Publication
(10) Pub. No.: US 2006/0294339 A1
(43) Pub. Date: Dec. 28, 2006

(54) Abstracted dynamic addressing

(76) Inventors: Sanjeev N. Trika, Hillsboro, OR (US); Robert Royer, Portland, OR (US); John I. Garney, Portland, OR (US); Richard P. Mangold, Forest Grove, OR (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/167,948

(22) Filed: Jun. 27, 2005

(51) Int. Cl. G06F 12/00

(52) U.S. Cl. 711/202

(57) ABSTRACT

Embodiments of abstracted dynamic addressing are generally described herein. Other embodiments may be described and claimed.

### RELATED APPLICATIONS

This disclosure is related to pending U.S. patent application Ser. No. 10/722,813, titled “Method and Apparatus to Improve Memory Performance,” and filed on Nov. 26, 2003; and pending U.S. patent application Ser. No. 10/726,418, titled “Write-Back Disk Cache,” and filed on Dec. 3, 2003.

### LIMITED COPYRIGHT WAIVER

A portion of the disclosure in this patent document contains material to which the claim of copyright protection is made. The copyright owner has no objection to the facsimile reproduction by any person of this patent document or the patent disclosure as it appears in the U.S. Patent and Trademark Office records, but reserves all other rights whatsoever.

### TECHNICAL FIELD

Various embodiments described herein relate to information processing generally, including apparatus, systems, and methods used to store and retrieve information, as well as mechanisms for mapping information in a memory.

### BACKGROUND INFORMATION

Many companies are investing in the development of new non-volatile mass storage systems scaled to operate with smaller computers, such as desktop units. The use of such systems may give rise to a variety of technological challenges, such as improving operational speeds, and maintaining the integrity of the information stored therein, especially during and after the occurrence of abnormal shutdown events.

### BRIEF DESCRIPTION OF THE DRAWINGS

FIG. 1 is a block diagram of apparatus and systems according to various embodiments of the invention.

FIGS. 2A-2C include a flow diagram and procedures illustrating several methods according to various embodiments of the invention.

FIG. 3 is a block diagram of an article according to various embodiments of the invention.

### DETAILED DESCRIPTION

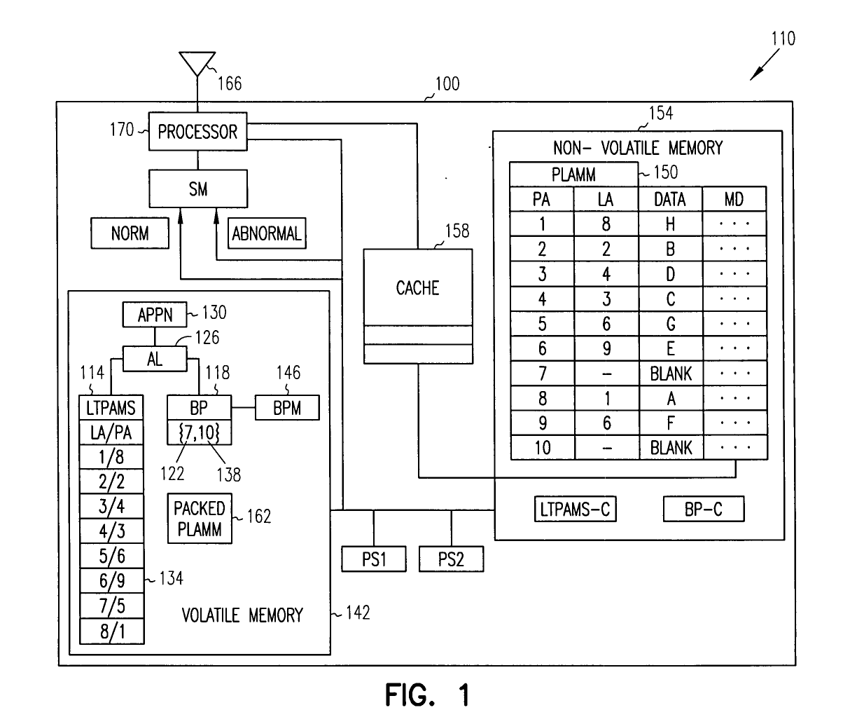

FIG. 1 is a block diagram of apparatus 100 and systems 110 according to various embodiments of the invention, which may implement dynamic addressing by relocating data from a source memory cell to a blank destination memory cell as part of a memory access operation.

In some embodiments, dynamic addressing may be implemented in hardware or software via logical-to-physical memory maps and blank pools. Some mechanisms may operate to preserve the advantages of dynamic addressing across reboot operations, including those encountered after the occurrence of normal and abnormal shutdown events. Dynamic addressing logic may be abstracted into a separate functional layer so that the feature can be built into a variety of applications (e.g., solid-state disk (SSD), disk caches, etc.). Least-recently-used blank policies may be used to improve dynamic addressing performance for some memories that lock out segments while processing/recovering-from prior accesses (e.g., polymer memories). Dynamic addressing may also be used to load-level the number of accesses to memory words, which can reduce cell access fatigue.

For the purposes of this document, a “blank cell” means a memory cell that contains no valid data or valid metadata. A blank cell also has no logical address. Those memory cells that are not located in a logical-to-physical mapping table are considered to be located in the blank pool. Thus, cells in a memory are either mapped or blank.

A cell may contain data and metadata. Data may include information supplied by an entity for storage in a medium, or may be retrieved from the medium by an entity after being stored there. Metadata may include information associated with storage medium operation. Thus, an example of data for a disk drive medium might be the 512 bytes of data stored in a sector. An example of metadata in this instance might include CRC (cyclic redundancy check) or ECC (error correcting code) information, and sector address information stored along with the sector data, but not visible to the same degree as the sector data.

A “blank pool” table contains physical addresses of memory wordlines or cells in non-volatile memory that are blank. A blank pool may be organized to permit identification of an appropriate blank candidate for use so that certain blank lines may be selected at a given time. Selection policies may include a random policy, a least-recently-used policy, a policy to reduce access time penalties, and a least-cells-destroyed policy (e.g., when cells are accessed in some memory types, the act of accessing the cell may disrupt or destroy the content of nearby cells; in this case, the least-destructive policy may operate so that the content of a lesser number of cells is disrupted or destroyed upon accessing the desired cell).

In some embodiments, an apparatus 100 may include a logical-to-physical address mapping structure (LTPAMS) 114, such as a memory mapping table, to track the physical location of each word or cell. The LTPAMS 114 may be implemented as an array that stores at index location X the physical location (address) of the logical word X. That is, the logical address LA of X is used as an index into the physical address PA content stored in the LTPAMS 114. It should be noted that the logical address LA content is not necessarily stored in the LTPAMS 114, but merely used as an index. Prior to accessing memory 142, the LTPAMS 114 may be initialized so that the logical address of word X (e.g., X) is set to the physical address of word X (e.g., [X]), for X less than the reported capacity, such that the reported capacity does not include reserved blank words or cells.

The apparatus 100 may also include a blank pool (BP) 118 that may be implemented as a priority queue or table of physical addresses of known blank cells. Sufficient numbers of blank cells should be kept in the BP 118 so that pending operations can be processed quickly at any given time; having more than one blank cells 122 available for processing pending operations increases the likelihood that a blank cell is available in a segment of the memory 142 that is not locked (e.g., due to processing/recovering from prior accesses). The BP 118 may be initialized to include as its content the set of all initial blank cells (e.g., all cells numbered between the reported capacity and the actual capacity). It is possible that an operation (e.g., erase) is applied to cells in the BP 118 before they are used. The operation may be applied to cells before they are placed in the BP 118, or afterwards, when they are extracted from the BP 118 for use.

In some embodiments, the apparatus 100 may include an abstraction layer (AL) 126 that encapsulates dynamic addressing logic and makes the dynamic addressing feature available for multiple applications (e.g., SSD, disk caching, etc.). The AL 126 may be used to manage various data structures, such as the LTPAMS 114 and the BP 118.

For example, when an application 130 requests access (e.g., read or write) to a memory cell 134 at logical address X, the physical address of the cell [X] may be looked up in the LTPAMS 114 for use as a source address. The highest priority blank in the BP 118 (e.g., blank 122) may be selected from the BP 118 and used as the destination address. Once the relocation operation is complete, the physical address of the cell [X] can be updated to the destination (which is now the physical address corresponding to the logical address X), and the source (which is now blank) can be placed in the BP 118 as a blank 138 with the lowest priority. This straightforward process maintains the content of the LTPAMS 114, while also implementing a least-recently-used blank management policy. Various other blank management policies are possible.

While some of the memories 142 in the apparatus 100 may comprise volatile memory (e.g., including one or more of the LTPAMS 114, the BP 118, the AL 126, and the application 130), it should be noted that one or more of the memories 154 in the apparatus 100 may also comprise non-volatile memory (e.g., a flash memory, a polymer memory, an electrically-erasable, programmable read-only memory, etc.), and the LTPAMS 114 and the BP 118 structures included in the memory 142 (e.g., volatile memory) can be written to the memory 154 (e.g., non-volatile memory) as a part of normal shutdown events to provide continued data integrity and dynamic addressing performance across system 110 reboots. For example, the apparatus 100 may include a system shutdown module SM to initiate saving addresses (e.g., a list of physical addresses PA and blanks 122, 138) included in the LTPAMS 114 and the BP 118. These addresses may be saved in the memory 154 as copies LTPAMS-C and BP-C of the LTPAMS 114 and BP 118, respectively, responsive to sensing normal shutdown operations NORM.

The data structures for the LTPAMS 114 and the BP 118 may be re-read during subsequent boot operations and normal dynamic addressing operations may continue. For example, pseudo-code illustrating how the AL 126 can be used to translate write operations (read operations are similar) to dynamic addressing operations, while maintaining the LTPAMS 114 and the BP 118 is shown in Table I below.

TABLE I

WriteCell (Logical_address X, Data d)
Source = LTPAMS [X]
Destination = BP.ExtractTopPriority ()
WriteCellWithRelocation (Source, Destination, d)
LTPAMS [X] = Destination
BP.AddWithLeastPriority (Source)

In Line 0001, the routine WriteCell is named, and can be called to write Data d to a logical address X. The source of the Data d may then be selected as the physical address [X] corresponding to the logical address X at line 0002. The destination for the Data d may be selected as the least recently used (e.g., highest or top priority) blank 122 in the BP 118 at line 0003. At line 0004, the Data d may be written to the destination cell (no longer blank), and the physical address [X] may be updated to reflect the destination at line 0005. Finally, the source (now blank) may be released to the BP 118 as a blank cell with the lowest priority (e.g., as the most recently used blank cell).

For read operations of a read-destructive memory, the same process is followed, except the WriteCellWithRelocation method may be replaced with a ReadCellWithRelocation and data is returned to the requesting entity, instead of provided.

Implementing the dynamic mapping mechanism described herein can provide several potential benefits. For example, the content of the LTPAMS 114 and the BP 118, when written to non-volatile memory, after reconstruction, may permit maintaining the integrity of stored information across shutdown events, as well as providing dynamic addressing across boot operations. In addition, the speed of traversing slower memories, such as polymer memories, during crash recovery operations may be improved (e.g., where each cell may be accessed in the case of write-back caching to flush dirty data to the cached device). Thus, a second pass after flushing operations following a crash or power failure may be obviated when metadata is reconstructed to determine what disk sectors are cached in which cache lines.

Therefore, many embodiments may be realized. For example, an apparatus 100 to provide dynamic mapping may include the LTPAMS 114 and the BP 118 coupled to the LTPAMS 114. The BP 118 may be ordered according to a least-recently-used blank policy (e.g., by a blank pool manager 146, operating to manage operation of the BP 118).

The apparatus 100 may include a physical-to-logical address mapping module (PLAMM) 150 coupled to the BP 118, and stored in a memory 154, such as a non-volatile memory. The memory 154 may be used to store addresses (e.g., logical addresses LA) included in the PLAMM 150 and metadata MD associated with information DATA indexed by the logical addresses LA. In some embodiments, the physical addresses PA may not be explicitly located in the PLAMM 150. Instead, the physical addresses PA may be used as an index into the PLAMM 150 to find the desired cell (e.g., the cell having metadata that includes the corresponding logical address LA). Such operations may be conducted in a manner similar to or identical to those conducted with respect to the LTPAMS 114.

To improve the speed of operation, some embodiments of the apparatus 100 may include a cache 158 to cache the metadata MD associated with information DATA referenced by the PLAMM 150 (coupled to the BP 118). A packed version of the PLAMM 150 (e.g., a packed PLAMM 162) including a table indexed by physical addresses PA and having columns for logical addresses LA and other data, may be stored in the memory 142.

Still other embodiments may be realized. For example, a system 110, such as a laptop computer or workstation, may include one or more apparatus 100, as described previously, as well as an antenna 166 (e.g., a patch, dipole, omnidirectional, or beam antenna, among others) to transmit information DATA stored in physical addresses PA indexed by the LTPAMS 114. The system 110 may include the memory 154, such as a non-volatile memory, to store content included in the LTPAMS 114 and the BP 118 (e.g., physical addresses PA in the LTPAMS 114, and blank addresses 122, 138 in the BP 118). For additional security, the system 110 may also include multiple power supplies, such as a primary power supply PS1 (e.g., to supply AC power) to provide power to the memories 142, 154 under normal conditions (e.g., prior to normal shutdown operations NORM), and a secondary power supply PS2 (e.g., battery power) to provide power to the memories 142, 154 responsive to sensing abnormal shutdown operations ABNORMAL.

An almost unlimited variety of embodiments may be realized. For example, the apparatus 100 may be embodied in a large capacity, nonvolatile disk cache incorporating dynamic addressing. The apparatus 100 may also be embodied in a SSD product that uses dynamic addressing.

Any of the components previously described can be implemented in a number of ways, including simulation via software. Thus, the apparatus 100; system 110; LTPAMS 114; BP 118; blank cells 122, 138; AL 126; application 130; memory cell 134; memories 142, 154; blank pool manager 146; PLAMM 150; cache 158; packed PLAMM 162; antenna 166; abnormal shutdown operations ABNORMAL; copies BP-C, LTPAMS-C; information DATA; logical addresses LA; metadata MD; normal shutdown operations NORM; physical addresses PA; power supplies PS1, PS2; and shutdown module SM may all be characterized as “modules” herein. The modules may include hardware circuitry, single or multi-processor circuits, memory circuits, software program modules and objects, firmware, and combinations thereof, as desired by the architect of the apparatus 100 and system 110 and as appropriate for particular implementations of various embodiments. These modules may be included in a system operation simulation package such as a software electrical signal simulation package, a power usage and distribution simulation package, a capacitance-inductance simulation package, a power/heat dissipation simulation package, a crash recovery and power failure recovery simulation package, or any combination of software and hardware used to simulate the operation of various potential embodiments. Such simulations may be used to characterize or test the embodiments, for example.

It should also be understood that the apparatus and systems of various embodiments can be used in applications other than SSD operation and disk caching. Thus, various embodiments of the invention are not to be so limited. The illustrations of apparatus 100 and system 110 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers, handheld computers, workstations, radios, video players, vehicles, and others.

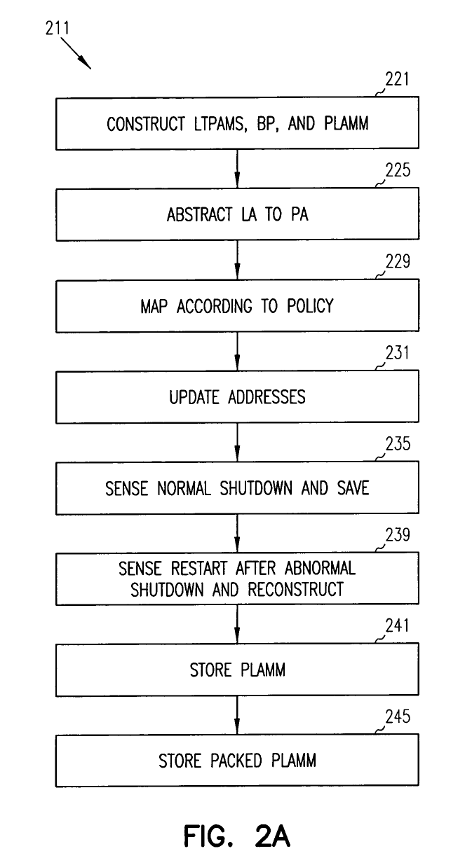

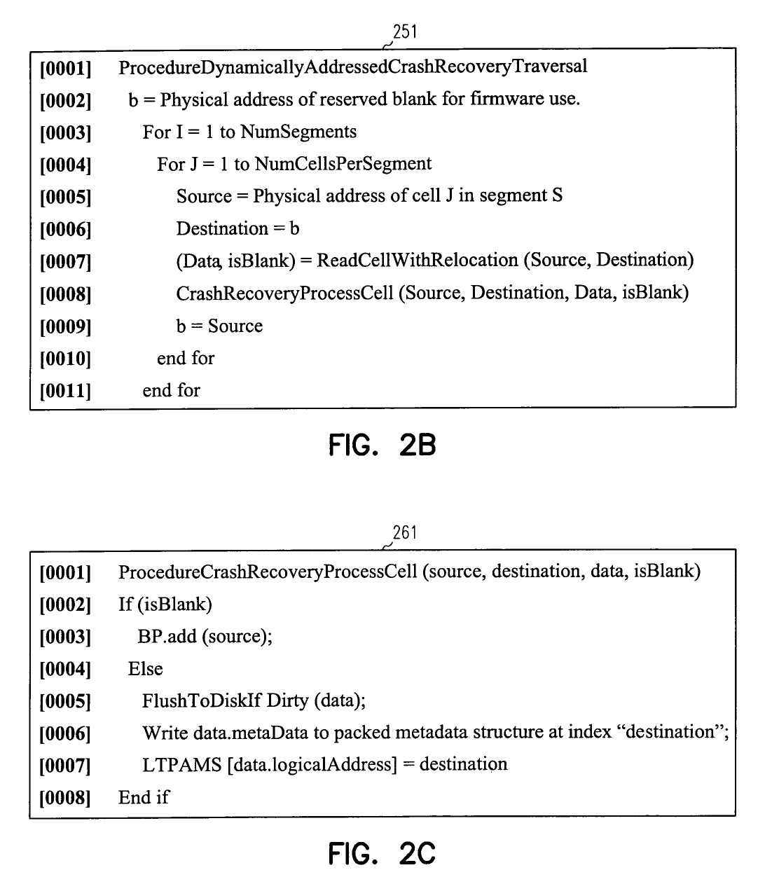

Some embodiments may include a number of methods. For example, FIGS. 2A-2C include a flow diagram and procedures illustrating several methods 211, 251, and 261 according to various embodiments of the invention. One such method 211 may begin at block 221 with constructing an LTPAMS, a BP, and a PLAMM. For example, constructing a PLAMM may include constructing a PLAMM having mapping data including content associated with the BP, as shown with respect to the LTPAMS 114, BP 118, and PLAMM 150 in FIG. 1. The mapping data may comprise disk sector mapping information, for example.

In some embodiments, construction activities at block 221 may involve combining mapping data and metadata for information referenced by the LTPAMS to form combined data, and storing the combined data in non-volatile memory. The information, which may include the actual data (see DATA in FIG. 1) may be stored in the non-volatile memory as well, perhaps interspersed with the logical address and metadata content. The mapping data may include physical-to-logical address mapping data. Some of the metadata may be cached in a volatile memory, if desired.

The method 211 may continue with abstracting one or more application logical addresses to a storage device or media physical address using the LTPAMS at block 225. The method 211 may include mapping physical addresses included in the LTPAMS according to a selection policy, which may comprise one of a least-recently-used policy, a random policy, and a least-destructive policy at block 229.

The method 211 may continue at block 231 with updating physical addresses included in the LTPAMS, and other addresses included in the BP upon accessing one or more memory cells, including non-volatile memory cells. The method 211 may include, at block 235, sensing a normal shutdown event (e.g., normal power-down operation of a desktop, laptop, or hand-held device), and storing the physical addresses (in the LTPAMS) and the other addresses (in the BP) in a non-volatile memory as a response to the normal shutdown event.

In some embodiments, the method 211 may include sensing a restart after an abnormal shutdown event (e.g., power failure, power surge, or system crash) at block 239, and reconstructing the physical addresses (in the LTPAMS) and the other addresses (in the BP) using the PLAMM coupled to the BP. In some embodiments, the method 211 may include reconstructing the other addresses in the BP without copying them to non-volatile memory. The method 211 may also include reconstructing the physical addresses in the LTPAMS from content in a non-volatile memory (e.g., a copy of the LTPAMS, or the PLAMM itself) after sensing an abnormal shutdown event.

The method 211 may include storing the PLAMM in a non-volatile memory at block 241. The method 211 may also include storing a packed version of the PLAMM in a volatile memory at block 245.

Many other embodiments may be realized. These include, for example, several different ways to recover content in the LTPAMS and BP after a system crash or power failure. One mechanism may involve updating the LTPAMS and BP in dynamic access memory (e.g., non-volatile memory) every time the tables are updated in volatile memory (e.g., dynamic random access memory), rather than only at shutdowns. While such a method may be relatively simple to implement, additional accesses to non-volatile memory may be needed to update the tables for every memory access.

Another possibility includes apparatus and systems having memory cells that include logical address information for the cell as part of its associated metadata information. A firmware crash recovery operation to check for dirty data can then load the logical address, and update the LTPAMS at substantially the same time. The crash recovery pass may also identify blank physical cache lines, so that the BP may be updated in a substantially parallel fashion. This mechanism may be useful for disk-caching, but may also use additional non-volatile memory to maintain the logical address in the memory cells.

In some embodiments (e.g., disk caching applications), some of the non-volatile memory overhead may be avoided if certain procedures are followed. For example, during the crash recovery traversal of non-volatile memory, blanks can be detected and added to a new BP table. The metadata in each cache line (e.g., memory cell) can indicate those disk sectors to which the data is mapped, and this information can be used to reconstruct (with knowledge of the caching policy in the firmware) the logical address for each physical address that is read.

As noted previously, in some embodiments, additional efficiency may be achieved by providing a battery backup circuit that will permit flushing the LTPAMS and BP content to non-volatile storage upon power failure. However, even if the battery fails before the data can be completely transferred to non-volatile storage, it may be possible to use one of the previously-discussed mechanisms to recover the LTPAMS and BP content.

In some embodiments, the LTPAMS and/or the BP content may be divided up into segments. Software, hardware, and combinations of these may be used to keep track of which segments have been modified and periodically flush corresponding portions of the LTPAMS and/or BP to non-volatile storage media. After a selected segment is flushed to non-volatile storage, a state bit (also stored in non-volatile media) may be set to indicate that the non-volatile copy is valid. Upon access to the selected segment, host software should operate to clear the state bit before it accesses the media using a dynamic addressing operation. This operating sequence provides the advantage that during crash/power-fail recovery, only those segments that have been modified (e.g., for which the “segment valid” state bit is clear) will be traversed when recovering LTPAMS and BP table content.

A method 251 of implementing dynamic addressing for cache traversal during crash recovery is shown in FIG. 2B. Here it can be seen that dynamic addressing during crash-recovery traversal may be enabled by reserving one or more blank memory cells for use by system firmware. During traversal activity, the firmware can use relocating addresses to traverse the memory cell while striding through the memory segments.

Thus, the method 251 may begin by calling a procedure for dynamic addressing during crash recovery at line 0001, and the physical address b may be reserved as a blank for firmware use at line 0002. An activity loop I that operates for each segment of the LTPAMS and BP may begin at line 0003, and end at line 0011. A second loop J may operate with respect to each cell in each segment, beginning at line 0004, and ending at line 0010.

A source of information may be set as the physical address of cell J in segment I, at line 0005, and the destination of the information may be set to physical address b at line 0006. Then the source of information (e.g., DATA in FIG. 1) may be relocated to the destination at line 0007, as described previously, and the crash recovery procedure may be implemented at line 0008 (see FIG. 2C, method 261, described below). Finally, the source cell may be set as a new reserved blank at line 0009. Thus, the method 251 may permit traversing a non-volatile memory array while avoiding recently-accessed segment lockout penalties, using dynamic addressing.

In some embodiments, the procedure described may be modified to avoid a potential lockout penalty on the first access (e.g., this may occur if the cell b is in the first segment, since both the source and destination addresses may then be located in the same segment). If desired, the outer loop I may be changed to start with a segment number that is different than the number of the segment that includes cell b, and then the loop I can be rolled back to cover the same segment at a later time. Multiple reserved blanks in multiple segments may also be supported, in case the underlying memory array is designed to lock out both read and write accesses. It should be noted that the procedure shown in FIG. 2B assumes that reads occurring in the ReadCellWithRelocation call do not lock out the source segment, as the source segment is used in the very next access for the destination.

In some embodiments, a disk-cache system can reconstruct the metadata used for continued caching without additional passes (e.g., a single-pass traversal may be implemented). This may be effected by using the CrashRecoveryProcessCell procedure shown in the method 261 of FIG. 2C, providing the ability to update a packed metadata or PLAMM structure (e.g., stored as part of a nonvolatile cache state) that might be assumed by a high-performance disk-caching driver. The packed structure may include the metadata of all the cache lines in one contiguous block. The packed structure may be saved as a part of normal shutdown events, and it may or may not be saved during crashes and power failures (e.g., abnormal shutdown events).

The CrashRecoveryProcessCell procedure of line 0001, in addition to other actions (e.g., dirty data flushing), can copy metadata for a read cache line into the packed block. On a subsequent driver load, it may not be necessary for the driver to read the entire cache to determine the cache metadata values, avoiding additional traversal operations.

Thus, the method 261 may begin at line 0001, after being passed the source, destination, and data values. If the source is determined to be blank at line 0002, then it is added to the BP at line 0003. Otherwise, dirty data is flushed and metadata is copied at lines 0004 to 0008. If the data is dirty, flushing occurs at line 0005. The data is written to the packed metadata structure (e.g., the packed PLAMM) at line 0006, and the LTPAMS is updated at line 0007. The result is that the content of the LTPAMS and the BP, as well as the associated metadata, can be recovered, and dirty cache lines flushed, in a single traversal of the cache using dynamic addressing, if desired (e.g., by combining the methods 251 and 261). In some embodiments, it is assumed that the LTPAMS has been initialized to contain only invalid values before the cache traversal for crash recovery.

Myriad other embodiments may be realized. For example, a method of dynamic mapping may include combining mapping data and metadata for information referenced by the LTPAMS to form combined data, storing the combined data in non-volatile memory, and storing some of the metadata in a volatile memory (e.g., a dynamic random access memory, among others). Storing the metadata may include caching some of the metadata in the volatile memory. The mapping data may include physical-to-logical address information, such as disk sector mapping information. Some of the metadata included in the non-volatile memory may comprise wordline data associated with a memory wordline, and in some embodiments, the wordline data may not be included in the volatile memory.

In some embodiments, a method of recovery from a system crash or power failure may include sensing an abnormal shutdown event associated with a primary power supply to an LTPAMS and a BP, and copying content in the LTPAMS to non-volatile storage using a secondary power supply. This method may also include copying content in the blank pool to the non-volatile storage.

In some embodiments, a method of monitoring data integrity may include dividing the LTPAMS and/or the BP into a plurality of regions, copying content from some of the plurality of regions to non-volatile memory on a periodic basis, and monitoring the validity of the content. This method may also include determining that some portion of the content is invalid, and reconstructing information in the LTPAMS and/or the BP. Reconstructing information in the LTPAMS may include determining that some portion of the LTPAMS content is invalid and reconstructing information in the LTPAMS, perhaps by examining metadata stored in the non-volatile memory to locate logical address information. Similarly, reconstructing information in the BP may include examining metadata stored in the non-volatile memory to locate logical address information.

The methods described herein do not have to be executed in the order described, or in any particular order. Moreover, various activities described with respect to the methods identified herein can be executed in repetitive, serial, or parallel fashion. Information, including parameters, commands, operands, and other data, can be sent and received in the form of one or more carrier waves.

One of ordinary skill in the art will understand the manner in which a software program can be launched from a computer-readable medium in a computer-based system to execute the functions defined in the software program. Various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using a number of mechanisms well known to those skilled in the art, such as application program interfaces or interprocess communication techniques, including remote procedure calls. The teachings of various embodiments are not limited to any particular programming language or environment.

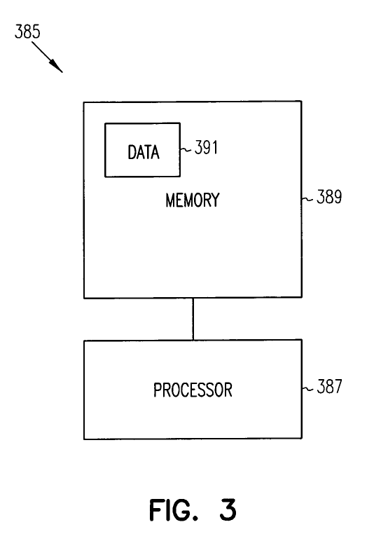

Thus, other embodiments may be realized. For example, FIG. 3 is a block diagram of an article 385 according to various embodiments of the invention. Examples of such embodiments may comprise a computer, a memory system, a magnetic or optical disk, some other storage device, or any type of electronic device or system. The article 385 may include one or more processor(s) 387 coupled to a machine-accessible medium such as a memory 389 (e.g., a memory including an electrical, optical, or electromagnetic conductor). The medium may contain associated information 391 (e.g., computer program instructions, data, or both) which, when accessed, results in a machine (e.g., the processor(s) 387) updating physical addresses included in an LTPAMS, and other addresses included in a BP, upon accessing one or more memory cells, such as non-volatile memory cells.

Additional activities may include combining mapping data and metadata for information referenced by the LTPAMS to form combined data, and storing the combined data and/or the information in non-volatile memory. Further activities may include caching some of the metadata in a volatile memory. The mapping data may include physical-to-logical address mapping data.

Implementing the apparatus, systems, and methods disclosed herein may operate to permit the use of dynamic addressing in multiple applications, increasing performance by avoiding memory-segment lockout penalties, and preserving data integrity and performance across reboots in a dynamic addressing system by writing the mapping and blank tables to non-volatile media.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. An apparatus, including:
a logical-to-physical address mapping structure; and
a blank pool coupled to the logical-to-physical address mapping structure.

2. The apparatus of claim 1, wherein the blank pool is ordered according to a least-recently-used blank policy.

3. The apparatus of claim 1, further including:
a physical-to-logical address mapping module coupled to the blank pool.

4. The apparatus of claim 3, further including:
a non-volatile memory to store addresses included in the physical-to-logical address mapping module and metadata associated with information indexed by the addresses.

5. The apparatus of claim 4, wherein the non-volatile memory comprises a polymer memory.

6. The apparatus of claim 1, further including:
a blank pool manager to manage operation of the blank pool.

7. The apparatus of claim 1, further including:
a system shutdown module to initiate saving addresses included in the logical-to-physical address mapping structure and the blank pool in a non-volatile memory responsive to sensing normal shutdown operations.

8. A system, including:
a logical-to-physical address mapping structure;
a blank pool coupled to the logical-to-physical address mapping structure; and
an antenna to transmit information stored in physical addresses indexed by the logical-to-physical address mapping structure.

9. The system of claim 8, further including:
a non-volatile memory to store the physical addresses included in the logical-to-physical address mapping structure and other addresses included in the blank pool.

10. The system of claim 9, wherein the non-volatile memory comprises a polymer memory.

11. The system of claim 9, further including:
a primary power supply to provide power to a volatile memory including the physical addresses under normal conditions; and
a secondary power supply to provide power to the non-volatile memory and the volatile memory responsive to sensing abnormal shutdown operations.

12. The system of claim 8, further including:
a cache to cache metadata associated with information referenced by a physical-to-logical address mapping module coupled to the blank pool.

13. A method, including:
updating physical addresses included in a logical-to-physical address mapping structure and other addresses included in a blank pool upon accessing a memory cell.

14. The method of claim 13, wherein accessing the memory cell further includes:
accessing a non-volatile memory cell.

15. The method of claim 13, further including:
sensing a normal shutdown event; and
storing the physical addresses and the other addresses in a non-volatile memory responsive to the normal shutdown event.

16. The method of claim 13, further including:
sensing a restart after an abnormal shutdown event; and
reconstructing the physical addresses and the other addresses using a physical-to-logical address mapping module coupled to the blank pool.

17. The method of claim 16, further including:
storing the physical-to-logical address mapping module in a non-volatile memory.

18. The method of claim 17, further including:
storing a packed version of the physical-to-logical address mapping module in a volatile memory.

19. The method of claim 13, further including:
reconstructing the other addresses without copying the other addresses to non-volatile memory.

20. The method of claim 13, further including:
reconstructing the physical addresses from content in a non-volatile memory after sensing an abnormal shutdown event.

21. The method of claim 13, further including:
abstracting an application logical address to a storage device physical address using the logical-to-physical address mapping structure.

22. The method of claim 13, further including:
mapping physical addresses included in the logical-to-physical address mapping structure according to a selection policy.

23. The method of claim 22, wherein the selection policy comprises one of a least-recently-used policy, a random policy, or a least-destructive policy.

24. The method of claim 13, further including:
constructing a physical-to-logical address mapping module having mapping data including content associated with the blank pool.

25. The method of claim 24, wherein the mapping data comprises disk sector mapping information.

26. An article including a machine-accessible medium having associated information, wherein the information, when accessed, results in a machine performing:
updating physical addresses included in a logical-to-physical address mapping structure and other addresses included in a blank pool upon accessing a memory cell.

27. The article of claim 26, wherein the information, when accessed, results in a machine performing:
combining mapping data and metadata for information referenced by the logical-to-physical address mapping structure to form combined data; and
storing the combined data in a non-volatile memory.

28. The article of claim 27, wherein the information, when accessed, results in a machine performing:
caching some of the metadata in a volatile memory.

29. The article of claim 27, wherein the mapping data includes physical-to-logical address mapping data.

30. The article of claim 27, wherein the information, when accessed, results in a machine performing:
storing the information referenced by the logical-to-physical address mapping structure in the non-volatile memory.
